(19) United States
(12) Patent Application Publication
(10) Pub. No.: US 2024/0375967 A1
(43) Pub. Date: Nov. 14, 2024

(54) METHODS OF PREPARING SILICA AEROGELS AND AEROGELS PREPARED THEREBY

(71) Applicant: DRAGONFLY INSULATION LIMITED, Prudhoe, Northumberland (GB)

(72) Inventor: Xiao Han, Prudhoe (GB)

(73) Assignee: DRAGONFLY INSULATION LIMITED, Prudhoe, Northumberland (GB)

(21) Appl. No.: 18/692,215

(22) PCT Filed: Sep. 12, 2022
(86) PCT No.: PCT/GB2022/052302

§ 371 Date: Mar. 14, 2024

(30) Foreign Application Priority Data
Sep. 17, 2021 (GB) 2113333.5

(51) Int. Cl. C01B 33/158; C01B 33/154

(52) U.S. Cl. CPC C01B 33/1585; C01B 33/1546

(57) ABSTRACT

The present invention relates to aerogels, and more particularly to ambient pressure methods for the synthesis of silica aerogels. In embodiments, the invention relates to methods for preparing controlled-shape fibre reinforced silica aerogel composites.

The present invention relates to methods of preparing aerogels, as well as to aerogels prepared thereby. More particularly, the invention relates to methods of preparing silica aerogels using rapid ambient pressure drying.

Aerogels are porous materials with a high specific surface area, which have a range of commercial applications in diverse sectors such as construction, insulation, catalysis and drug delivery. In particular, aerogels can be used as an aggregate in cement applications to provide lightweight and insulating properties.

Aerogels are typically manufactured via a sol-gel process, in which a three dimensional ‘wet-gel’ skeleton is obtained, before solvent exchange and/or drying are carried out to yield the porous aerogel structure.

A major impediment to the large scale commercialisation of aerogels is the drying step.

Freeze-drying processes for the production of aerogels are known (Klvana et al. A New Method of Preparation of Aerogel-like Materials using a Freeze-Drying Process. Journal De Physique (1989): 50; C429-432). However, freeze drying methods rely on the sublimation of the frozen drying solvent under vacuum, and are heavily energy intensive. Supercritical drying, another known technique, utilises high pressures to reach the supercritical point of the drying solvent and requires both high pressures and high temperatures (Anderson et al., Hydrophobic silica aerogels prepared via rapid supercritical extraction; Journal of Sol-Gel Science and Technology (2010); 53; 199-207). The high energy requirements of these processes limit their commercial feasibility.

Ambient pressure drying (APD) methods therefore provide a less energy intensive route to aerogels. Conventional APD methods rely on displacing the original solvent used for wet-gel preparation with lower surface tension organic solvents, such as hexane, heptane or octane. The methods often also include additional surface modification, to replace the —OH groups on the silica surface with more lipophilic groups, thereby facilitating drying. Trimethylchlorosilane (TMCS) has been used for the surface modification of silica gels—however, this leads to the generation of HCl, which typically must be removed. WO2016/132117 describes the reaction of the HCl produced during surface modification with TMCS with carbonate or bicarbonate ions in the silica wet-gel to generate CO₂ gas within the pores of the wet-gel from the inside. This allows for more rapid drying of the wet-gel, with ambient pressure drying. However, improvements are still needed, in terms of economy, efficiency and the form of the aerogels produced.

It is an aim of the invention to obviate or mitigate one or more of the disadvantages associated with the prior art. A scalable method for the preparation of silica aerogels would be beneficial. A less energy intensive method would be useful, as would be a method which allows for a reduction in solvent use. A method for the preparation of silica aerogels with reduced processing/drying time would be particularly advantageous, as would a cost-effective method for producing same. A method which could be used to form controlled-shaped aerogels would be particularly beneficial.

### SUMMARY

The present invention relates to methods of preparing aerogels, such as silica aerogels, in which chemically driven self-pressurisation reactions occurring both inside and outside the wet-gel during production facilitates rapid drying under ambient pressure conditions. In embodiments, the aerogels can be prepared with fibres to allow for the preparation of controlled shaped products. Advantageously, the aerogels can be rapidly prepared under ambient pressure conditions, leading to a reduction in time costs and energy consumption, thereby facilitating scale-up of the process.

Accordingly, in a first aspect of the present invention there is provided a method of preparing a silica aerogel, the method comprising providing a precursor solution comprising a silicate and optionally a carbonate solution; and reacting the precursor solution with a bicarbonate and with a silylating agent, wherein the bicarbonate is in the form of a solid.

In this process, initial gelation is achieved by the reaction of the silicate with the bicarbonate, yielding a silica wet-gel shell, carbonate and water, while the silylating agent also reacts with the silicate, causing further gelation and modifying the wet-gel shell surface, while yielding HCl.

The silylating agent also reacts with the HCl produced and the carbonate, either formed as a by-product or optionally present in the precursor solution, to form CO₂. In this manner, external pressurisation occurs, i.e. at the external surface of the wet-gel shell, which facilitates rapid drying.

In addition, unreacted silylating agent and generated HCl within the pores of the wet-gel, diffuse into the wet-gel shell core, reacting with the bicarbonate to produce CO₂, thereby pressurising it from the inside and further facilitating the drying step.

The steps of reacting the precursor solution with a bicarbonate and a silylating agent may be carried out sequentially, i.e. in which the precursor solution is reacted first with a bicarbonate, and subsequently with a silylating agent; or the steps may be carried out simultaneously.

An embodiment of the invention therefore relates to a method of preparing a silica aerogel, the method comprising preparing a wet-gel by providing a precursor solution comprising a silicate and optionally a carbonate solution, and reacting the precursor solution with a bicarbonate and with a silylating agent, wherein the bicarbonate is in the form of a solid; and drying the wet-gel to form a silica aerogel.

In an embodiment of the invention, the step of reacting the precursor solution with the bicarbonate is carried out in the presence of fibres. The fibres can be added to the precursor solution, or to the bicarbonate powder, before the reaction takes place. This can be useful when it is required that the aerogels have a controlled shape. However, in embodiments, the fibres are not present, and the aerogel is produced as an uncontrolled solid. This can be subsequently pulverized or ground to form a powder or granules depending on the intended use.

In an embodiment, the fibres are ceramic fibres, organic fibres or carbon fibres.

In an embodiment, the fibres are ceramic fibres. Triton™ ceramic short fibres are an illustrative example of fibres which can be used, although one skilled in the art would appreciate that alternative fibres can be used.

Advantageously, when fibres are used, the method allows for the rapid production of controlled shaped reinforced aerogel composites.

The term composite is used to describe an aerogel with one or more additional components, such as the fibres which can be introduced into the aerogel structure.

In an embodiment, the fibres surround the bicarbonate powder. The fibres can be formed into a shape around the bicarbonate powder. For example, the fibres can be shaped into a sphere or ball surrounding the bicarbonate powder. In this embodiment, the sphere can be soaked in the precursor solution. The fibres can impart structural integrity to the resultant aerogel, allowing for the preparation of controllable hollow aerogel composites; in this example a fibre-reinforced hollow aerogel composite (FRHAC).

Additionally, in this embodiment, the CO₂ generated at the external surface of the wet-gel shell is retained within the shaped structure until it is released via the pores of the silica wet-gel. As the gas can displace the liquid component of the gel, drying can be achieved at low temperature and pressure, making the process energy efficient.

Accordingly, the invention relates to a method of the production of a silica aerogel, the method comprising providing a precursor solution comprising a silicate and optionally a carbonate solution; and reacting the precursor solution with a bicarbonate and a silylating agent, wherein the bicarbonate is in the form of a solid, and wherein reacting the precursor solution with the bicarbonate is carried out in the presence of fibres.

In an embodiment, the invention relates to a method of the production of a silica aerogel, the method comprising providing a precursor solution comprising a silicate and optionally a carbonate solution;
providing fibres surrounding a bicarbonate core to form a shaped structure;
reacting the precursor solution with the bicarbonate and a silylating agent, wherein the bicarbonate is in the form of a solid.

In an embodiment, in the step of reacting the precursor solution with the bicarbonate, the shaped structure is immersed in the precursor solution. In this way, the precursor solution can soak through the fibres and react with the bicarbonate powder core.

While the fibres advantageously create a shaped structure in which the CO₂ produced is retained until it diffuses through the pores of the wet-gel, a similar effect can be achieved without the fibres, by preparing the wet-gel on a substrate. When the precursor reacts with the bicarbonate powder, a wet-gel is formed as a layer. In this embodiment, the CO₂ is retained between the substrate and the external surface of the wet-gel layer, until it is released via the pores of the wet-gel. Suitable substrates would be known to a person skilled in the art, and include, for example, glass, ceramic and polymer substrates.

In an embodiment, the silicate is selected from sodium silicate, potassium silicate, lithium silicate or calcium silicate.

In an embodiment, the silicate is sodium silicate.

Sodium silicate, also known as “waterglass” is particularly suitable for use in the present invention.

In an embodiment, the carbonate is selected from sodium carbonate, potassium carbonate, calcium carbonate, magnesium carbonate, iron carbonate and ammonium carbonate.

In an embodiment, the carbonate is sodium carbonate.

In an embodiment, the bicarbonate is selected from sodium bicarbonate, potassium bicarbonate, calcium bicarbonate, magnesium bicarbonate, iron bicarbonate and ammonium bicarbonate.

In an embodiment, the bicarbonate is sodium bicarbonate.

In an embodiment, the silylating agent has the general formula R₃SiX, in which R is a C₁-C₄ alkyl or halide, and X is a halide, sulfate or sulfonate group.

The halide can be chloride, bromide or iodide.

The sulfonate can be methyl sulfonate, trifluoromethylsulfonate, benzylsulfonate or tolouenesulfonate.

The sulfate may be —O—S(O)₂—OSiR₃.

In an embodiment, the silylating agent is trimethylchlorosilane (TMCS), dimethyldichlorosilane, methyltrichlorosilane and bis(trimethylsilyl)sulfate.

In an embodiment, the silylating agent is trimethylchlorosilane (TMCS).

The method of the invention produces a partially dried aerogel, which could be the end product. However, in embodiments, one or more washing and/or drying steps may be carried out to obtain the final aerogel product.

In an embodiment, the method comprises one or more washing steps.

In an embodiment, the method comprises one or more drying steps. The drying step(s) can be performed by conventional means, such as in an oven or on a heat plate. Suitable heating methods would be apparent to one skilled in the art.

The drying step comprises heating under ambient pressure.

The heating may be carried out at a temperature of from 60° C. to 500° C. In an embodiment, the heating is carried out at from 60° C. to 150° C.

Temperatures around 100° C. (e.g. from 80° C. to 120° C.) may be preferred, since the liquid phase has a boiling point no higher than 100° C.

The drying step may be performed for from 15 minutes to 24 hours. As would be understood by one skilled in the art, the length of the drying step will depend on the heating temperature, with lower temperatures requiring longer drying times. In an embodiment, the drying step is performed for from 15 minutes to 12 hours, or from 15 minutes to 6 hours. In an embodiment, the drying step is carried out for from 20 minutes to 3 hours, or from 30 minutes to 2 hours. When the drying temperature ranges from 60° C. to 150° C., the drying time may be from 30 minutes to 12 hours, from 30 minutes to 8 hours, from 30 minutes to 6 hours or from 30 minutes to 2 hours.

### EXAMPLES

The invention will now be described by way of example only with reference to the accompanying figures, in which:

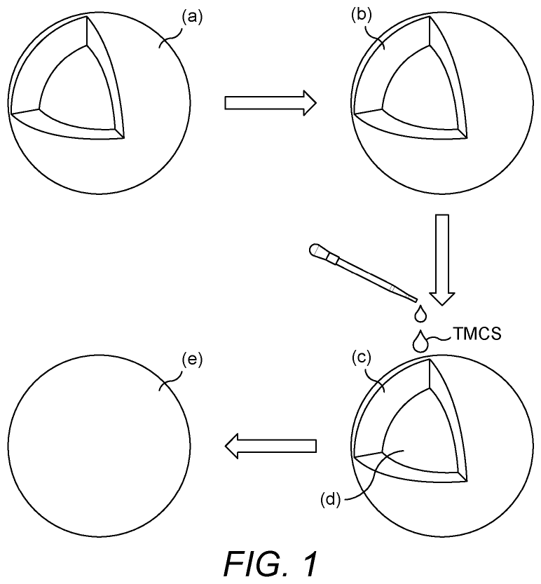

FIG. 1 illustrates a schematic of a method according to an embodiment of the invention;

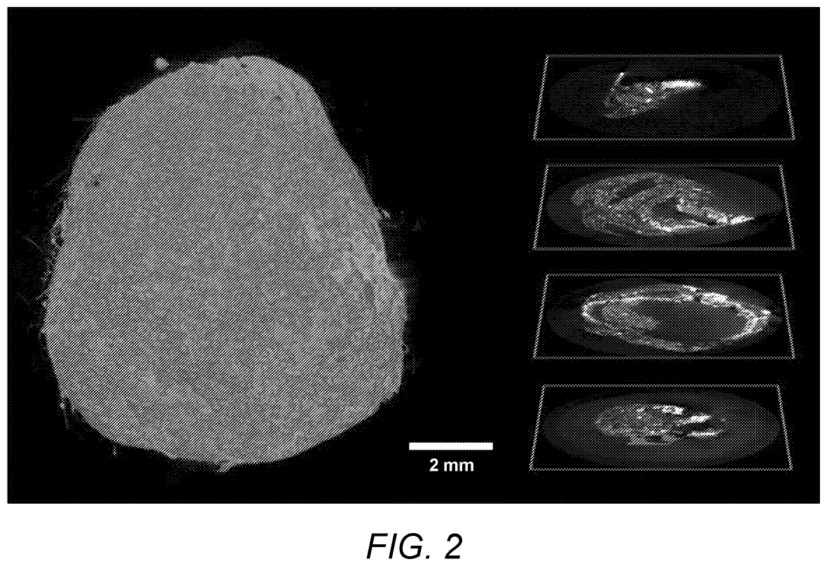

FIG. 2 shows X-ray tomographic images of a FRHAC prepared according to an embodiment of the invention;

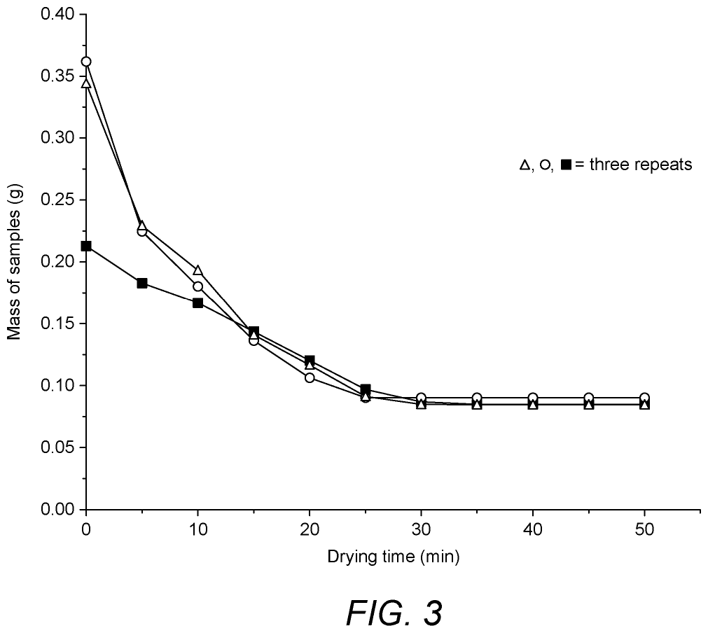

FIG. 3 shows mass changes of fibre-reinforced aerogel composites prepared according to an embodiment of the invention;

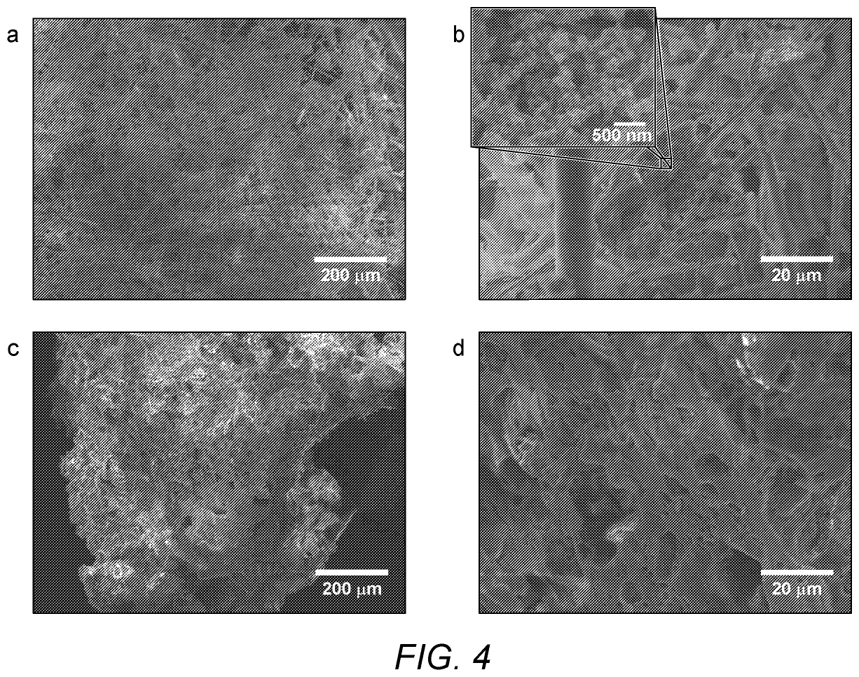

FIG. 4 shows SEM images of (a) and (b) fibre-reinforced aerogel composites and (c) and (d) aerogels, prepared according to the invention.

### DETAILED DESCRIPTION

An embodiment of the invention will now be described in detail with reference to FIG. 1, and with reference to the reactions listed below. In FIG. 1(a), a ball of ceramic short fibres is shaped to surround a core of bicarbonate powder. The size of the composite aerogel prepared can be adjusted by changing the amount of short fibres used.

As shown in FIG. 1(b) gelation occurs via the reaction of the sodium silicate with the sodium bicarbonate core, leading to the formation of a silica gel shell.

Although in the figure shown sodium carbonate is included in the precursor, a skilled person would recognise that as sodium carbonate is formed as a product of the reaction between the sodium silicate and the sodium bicarbonate, the sodium carbonate is not required in the precursor solution, i.e. it is an optional component.

A silylation agent is then added dropwise to the surface of the silica gel (FIG. 1(c)), leading to surface modification and further gel formation, while forming HCl. The silylating agent and the HCl produced also react with the carbonate, to form CO₂. In addition, unreacted silylating agent and HCl generated within the pores of the gel diffuse into the core (FIG. 1(d)), reacting with the solid bicarbonate to produce CO₂. As the silica gel shell is mechanically reinforced by the short fibres, the silica gel shell does not expand during the rapid gas generation step (FIG. 1(e)) and retains the increased pressure produced by the gas generation until the CO₂ is released via the pores of the shell.

The reactions that take place during this process are as follows:

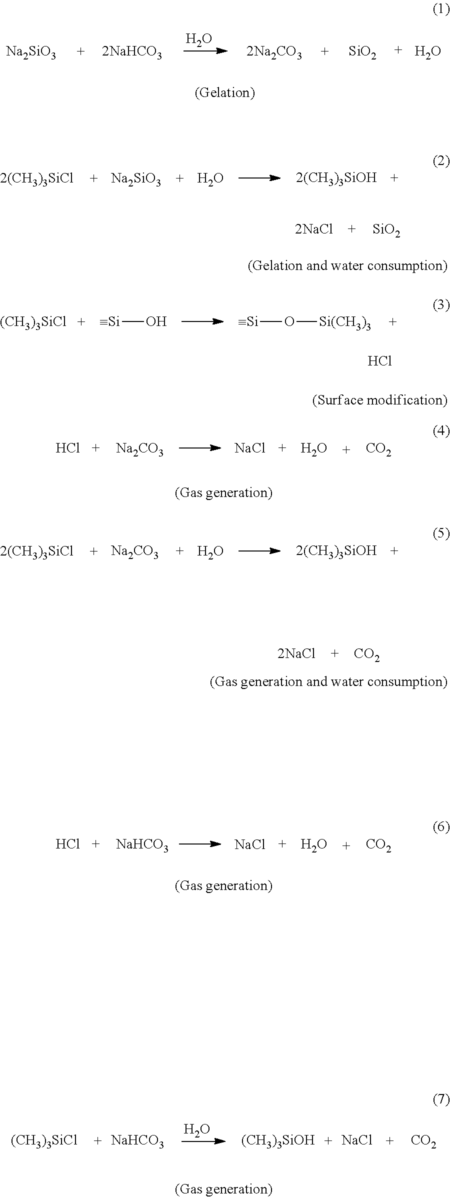

At the beginning of the process, the sodium silicate (Na₂SiO₃) solution mixes with the short fibres and reacts with the sodium bicarbonate (NaHCO₃) powder core to form a silica gel shell due to (reaction 1).

After addition of the silylating agent, in this embodiment trimethylchlorosilane (TMCS), onto the silica gel shell, further silica gel is formed due to the reaction between TMCS and remaining sodium silicate (Reaction 2), and the surface of the silica gel is modified by TMCS. As a result of the surface modification by TMCS, the FRHAC have hydrophobic properties. The reaction also produces hydrochloric acid (HCl) as a result (Reaction 3). The TMCS and the generated HCl react with the sodium carbonate (Na₂CO₃) to generate carbon dioxide (CO₂) gas (Reaction 4 and 5).

The unreacted TMCS and the generated HCl in the pores of the generated silica gel shell diffuse into the core of sodium bicarbonate. CO₂ gas is generated causing a sudden increase in the pressure (Reaction 6 and 7) against the silica gel shell. As the silica gel can behave in a non-Newtonian manner and the silica gel shell is mechanically reinforced by short fibres, the silica gel shell does not expand during the rapid gas generation stage and retains the sudden increase in pressure until the generated CO₂ gas is slowly released via the pores of the silica gel shell. A hollow structure is therefore obtained as shown in the X-ray tomographic images (FIG. 2).

Reaction 7 is the overall reaction between TMCS and sodium bicarbonate solution. This chemical process, therefore, not only forms CO₂ gas, but also consumes water which brings a great benefit to the heat drying for the wet-gels.

### EXAMPLES

The invention will now be fully described with reference to the following illustrative examples.

### Example 1

### Materials and Methods

Sodium carbonate (≥99%), sodium bicarbonate (≥99.7%) and trimethylchlorosilane (TMCS, ≥97%) were purchased from Sigma-Aldrich™ and used without any further purification. Ceramic short fibres Triton™ and sodium silicate (waterglass) solution were purchased from Fisher Scientific™.

A FEI XL30 ESEM-FEG (Environmental Scanning Electron Microscope-Field Emission Gun) at Newcastle University was used to image the samples in high vacuum mode with a 10 keV accelerating voltage. Before SEM imaging, all samples were coated with gold to increase electrical conductivity. The specific surface area and porosity of the samples was characterised by nitrogen adsorption-desorption method via Thermo Scientific™ SURFER at Newcastle University. A pCT, Xradia 410 Versa at 4 μm isotropic voxel size at Durham University was used for X-ray micro-tomography scanning. A software Avizo 9 was used to process the obtained tomography datasets.

### 1.1 Fibre Reinforced Hollow Aerogel Composites (FRHAC)

To prepare fibre-reinforced hollow aerogel composites (FRHAC), a precursor was initially prepared with a mixture of waterglass, de-ionised water and sodium carbonate solution (molar ratio Si:H₂O:Na₂CO₃=5:167:1). A shaped ball of ceramic short fibres weighing 0.03 g covering a core of 0.1 g of sodium bicarbonate was prepared by manually shaping the fibres. The shaped ball was then soaked in 1 ml of precursor, before 1 ml of trimethylchlorosilane was added dropwise to the surface. After the 10 min, it was washed by deionised water for 3 times. Finally, the FRHAC sample was dried on at 100° C. for 24 hours.

### 1.2 Non-Reinforced Aerogel (NRA)

An aerogel sample without ceramic short fibres was prepared by adding 1 ml of precursor directly onto 1 g of sodium bicarbonate powder without stirring and subsequently adding 1 ml of TMCS to the surface. Bubbling on the surface was observed as liquid was displaced during the release of the gas via the pores of the wet-gel. After the bubbling stopped, the gel was washed with de-ionised water 3 times, and finally dried on a hotplate at 100° C. for 24 hours.

### 1.3 Characterisation

The NRA sample was ground to the powder in order to try to mechanically open any blocked pores and determine the real surface area. Grounded powder was firstly washed twice with deionised water, dried and characterized. In addition, the grounded powder was washed with ethanol three times to remove all by-products of synthesis and then repeatedly characterized.

### 1.3.1 Minimum Heat Drying

The minimum heat drying time for the FRHAC synthesised in example 1.1 was determined by monitoring the mass loss from beginning of drying. Each experiment was performed in triplicate, and the results are shown in FIG. 3. This shows that after 30 minutes of heat drying at 100° C., the mass loss stops and the gel is dried completely.

### 1.3.2 SEM

In the SEM images of FRHAC (FIGS. 4(a) and (b)), various sized pores, from micropores to macropores, can be observed. The porous structures of the aerogel sample without fibre-reinforcement (NRA) can be observed in FIGS. 4(c) and (d).

The bulk density of FRHAC and NRA were obtained from the weight and volume and are shown in Table 1 below. The pores of the FRHAC and NRA samples were analysed by nitrogen adsorption-desorption isotherm method, and showed a specific surface area for the FRHAC of approximately 36 m²/g. Although the short fibres with a small specific surface area (6 m²/g) could lead to FRHAC having a lower specific surface area than the NRA without short fibres, the NRA specific surface area does not show a significant increase but is only around 39 m²/g.

In order to further study the properties of the aerogel component in the FRHAC, the NRA was ground into powders, resulting in an increased specific surface area of approximately 128 m²/g, indicating the dominance of macropores in the original NRA. Finally, the ground NRA powders were additionally washed by water. The specific surface area of the washed NRA powders was more than 10 times higher than the original NRA, suggesting that the by-product salt generated from the reactions 2, 4, 5, 6 and 7 was causing a lower specific surface area of the original NRA as analysed by nitrogen adsorption. The grinding and washing procedures also led to an increase of the pore volume from 0.55 cm³/g to 4.33 cm³/g (Table 1) that shows the unidentified micropores and mesopores in the original FRHAC samples.

TABLE 1
Bulk density, BET surface area and pore analysis of fibre-
reinforced hollow aerogel composite (FRHAC), non-reinforced
aerogel samples (NRA), and short fibres.

| | Bulk | BET | Pore |
|---|---|---|---|
| | density | surface area | volume |
| Sample | (g/cm³) | (m²/g) | (cm³/g) |
| FRHAC | 0.24 | 35.6 | 0.55 |
| NRA | 0.09 | 38.5 | 0.65 |
| NRA powders | — | 128.1 | 1.08 |
| NRA powders after | — | 478.9 | 4.33 |
| further washing | | | |
| Short fibres | — | 5.5 | 0.12 |

The results show that the process of the present invention can be used to rapidly prepare aerogels, with significantly reduced time and energy consumption. In particular, the results show that aerogels can be prepared and fully dried with a drying time in the order of 30 minutes. In embodiments, the reinforced by short fibres enables the production of controlled shape aerogel products with a vast range of potential commercial applications.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A method of preparing a silica aerogel, the method comprising:
providing a precursor solution comprising a silicate an optionally a carbonate solution; and
reacting the precursor solution with a bicarbonate;
and with a silylating agent;
wherein the bicarbonate is in the form of a solid.

2. The method of claim 1, wherein reacting the precursor solution with a bicarbonate is carried out in the presence of fibres.

3. The method of claim 2, wherein the fibres are ceramic fibres, organic fibres or carbon fibres.

4. The method of claim 3, wherein the fibres are ceramic fibres.

5. The method of claim 2, wherein the method further comprises providing fibres surrounding a bicarbonate core to form a shaped structure before reacting the precursor solution with the bicarbonate.

6. The method of claim 5, wherein reacting the precursor solution with the bicarbonate comprises immersing the shaped structure in the precursor solution.

7. The method of claim 1, wherein the silicate is selected from sodium silicate, potassium silicate, lithium silicate or calcium silicate.

8. The method of claim 7, wherein the silicate is sodium silicate.

9. The method of claim 1, wherein the carbonate is selected from sodium carbonate, potassium carbonate, calcium carbonate, magnesium carbonate, iron carbonate and ammonium carbonate.

10. The method of claim 9, wherein the carbonate is sodium carbonate.

11. The method of claim 1, wherein the bicarbonate is selected from sodium bicarbonate, potassium bicarbonate, calcium bicarbonate, magnesium bicarbonate, iron bicarbonate and ammonium bicarbonate.

12. The method of claim 11, wherein the bicarbonate is sodium bicarbonate.

13. The method of claim 1, wherein the silylating agent has the general formula R₃SiX, in which R is a C₁-C₄ alkyl or halide, and X is a halide, sulfate or sulfonate group.

14. The method of claim 13, wherein the silylating agent is trimethylchlorosilane (TMCS), dimethyldichlorosilane, methyltrichlorosilane or bis(trimethylsilyl)sulfate.

15. The method of claim 14, wherein the silylating agent is trimethylchlorosilane (TMCS).

16. The method of claim 1, further comprising a drying step.

17. The method of claim 16, wherein the drying step comprises heating under ambient pressure conditions.
